(19) United States
(12) Patent Application Publication
(10) Pub. No.: US 2017/0015944 A1
(43) Pub. Date: Jan. 19, 2017

(54) Hard surface cleaners comprising a solvent

(71) Applicant: The Procter & Gamble Company, Cincinnati, OH (US)

(72) Inventors: Aicha DKIDAK, Brussels (BE); Denis Alfred GONZALES, Brussels (BE); Marina Jozefa HERMIE, Hever (BE); James Robert TINLIN, Brussels (BE)

(21) Appl. No.: 15/206,342

(22) Filed: Jul. 11, 2016

(30) Foreign Application Priority Data
Jul. 13, 2015 (EP) 15176525.2

(51) Int. Cl. C11D 1/831; C11D 3/20; C11D 1/22; C11D 3/43; C11D 1/75

(52) U.S. Cl. CPC C11D 1/831; C11D 3/43; C11D 1/75; C11D 1/22; C11D 3/2068

(57) ABSTRACT

Hard surface cleaning compositions comprising a glycol ether solvent and from about 3% to about 15% by weight of surfactant, and having a pH of greater than about 7, can be used for removing stains, especially hydrophobic stains.

### FIELD OF THE INVENTION

Hard surface cleaning compositions comprising specific solvents for improved stain removal.

### BACKGROUND OF THE INVENTION

Hard surface cleaning compositions are used for cleaning and treating hard surfaces. Preferably, the hard surface cleaning composition is formulated to be an “all purpose” hard surface cleaning composition. That is, the hard surface cleaning composition is formulated to be suitable for cleaning as many different kinds of surfaces as possible. Hard surface cleaning compositions are typically diluted before use in a bucket before being applied to the surface being cleaned using a mop, sponge, cloth or similar device. However, for stubborn stains, direct application of the hard surface composition is often preferred. For instance, the composition can be sprayed onto the surface, or applied with little or no dilution onto the surface using a sponge or similar material. However, even with such direct treatment, stain removal from hard surfaces can be less than desired, particularly for hydrophobic stains. Moreover, suds longevity can be challenging, especially in the presence of hydrophobic residues. Since users can equate low suds with low cleaning effectiveness, especially when treating hard to remove hydrophobic stains, such low suds can lead to dissatisfaction with the cleaning composition.

Hence a need remains for liquid hard surface treatment compositions having improved effectiveness at removing such stubborn stains, which also provide more enduring suds even during treatment of hydrophobic stains.

US 2005/0233925 A1 relates to compositions comprising an organic solvent, for removing polymerised grease. US2004/0157763 A1 relates to hard surface cleaning compositions comprising an organic solvent and malodour control agent.

### SUMMARY OF THE INVENTION

The present invention relates to a liquid hard surface cleaning composition comprising from 3% to 15% by weight of a surfactant system, and a glycol ether solvent, such that the surfactant system and the glycol ether solvent are present in a weight ratio of from 5:1 to 1:1, and the composition has a pH of greater than 7.

The present invention further relates to a method of treating a hard surface, and the use of hard surface treatment compositions for removing stains, especially hydrophobic stains.

### DETAILED DESCRIPTION OF THE INVENTION

Hard surface cleaning compositions comprising a glycol ether solvent and from 3% to 15% by weight of surfactant, and having a pH of greater than 7, are highly effective for removing stains, especially hydrophobic stains.

Moreover, such compositions also provide a more enduring suds profile, even during the treatment of hydrophobic stains, especially when applied neat to the stain.

As defined herein, “essentially free of” a component means that no amount of that component is deliberately incorporated into the respective premix, or composition. Preferably, “essentially free of” a component means that no amount of that component is present in the respective premix, or composition.

As used herein, “isotropic” means a clear mixture, having little or no visible haziness, phase separation and/or dispersed particles, and having a uniform transparent appearance.

As defined herein, “stable” means that no visible phase separation is observed for a premix kept at 25° C. for a period of at least two weeks, or at least four weeks, or greater than a month or greater than four months, as measured using the Floc Formation Test, described in USPA 2008/0263780 A1.

All percentages, ratios and proportions used herein are by weight percent of the premix, unless otherwise specified. All average values are calculated “by weight” of the premix, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

Liquid Hard Surface Cleaning Compositions:

By “liquid hard surface cleaning composition”, it is meant herein a liquid composition for cleaning hard surfaces found in households, especially domestic households. Surfaces to be cleaned include kitchens and bathrooms, e.g., floors, walls, tiles, windows, cupboards, sinks, showers, shower plastified curtains, wash basins, WCs, fixtures and fittings and the like made of different materials like ceramic, vinyl, no-wax vinyl, linoleum, melamine, glass, steel, kitchen work surfaces, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments.

In a preferred embodiment, the liquid compositions herein are aqueous compositions. Therefore, they may comprise from 30% to 99.5% by weight of the total composition of water, preferably from 50% to 98% and more preferably from 80% to 97%.

The compositions of the present invention preferably have a viscosity from 1 cps to 650 cps, more preferably of from 100 cps to 550 cps, more preferably from 150 cps to 450 cps, even more preferably from 150 cps to 300 cps and most preferably from 150 cps to 250 cps when measured at 20° C. with a AD1000 Advanced Rheometer from Atlas® shear rate 10 s⁻¹ with a coned spindle of 40 mm with a cone angle 2° and a truncation of ±60 μm.

The pH is greater than 7, preferably from 7.0 to 12, more preferably from 7.5 to 11.5, even more preferably from 9.5 to 11.3, most preferably 10 to 11. It is believed that the greasy soil and particulate greasy soil cleaning performance is further improved at these preferred alkaline pH ranges. Accordingly, the compositions herein may further comprise an acid or base to adjust the pH as appropriate.

A suitable acid for use herein is an organic and/or an inorganic acid. A preferred organic acid for use herein has a pKa of less than 6. A suitable organic acid is selected from the group consisting of: citric acid, lactic acid, glycolic acid, succinic acid, glutaric acid and adipic acid and mixtures thereof. A suitable inorganic acid can be selected from the group consisting of: hydrochloric acid, sulphuric acid, phosphoric acid and mixtures thereof.

A typical level of such acids, when present, is from 0.01% to 5.0% by weight of the total composition, preferably from 0.04% to 3.0% and more preferably from 0.05% to 1.5%.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate, K₂CO₃, Na₂CO₃ and alkanolamines (such as monoethanolamine, triethanolamine, aminomethylpropanol, and mixtures thereof). Alkanolamines, especially methanolamine, are particularly preferred.

Typical levels of such bases, when present, are from 0.01% to 5.0% by weight of the total composition, preferably from 0.05% to 3.0% and more preferably from 0.1% to 2.0%.

For improved stain penetration, the liquid hard surface treatment composition preferably has a reserve alkalinity of from about 0.1 to about 1, preferably from 0.2 to 0.7, more preferably from 0.3 to 0.5 expressed as g NAOH/100 ml of composition at a pH of 7.

All ratios are calculated as a weight/weight level, unless otherwise specified.

The Solvent:

The hard surface cleaning composition comprises a glycol ether solvent selected from the glycol ethers of Formula 1 or Formula 2.

R₁O(R₂O)ₙR₃ Formula 1:
wherein
R₁ is a linear or branched C₄, C₅ or C₆ alkyl, a substituted or unsubstituted phenyl, preferably n-butyl. Benzyl is one of the substituted phenyls for use herein.
R₂ is ethyl or isopropyl, preferably isopropyl
R₃ is hydrogen or methyl, preferably hydrogen
n is 1, 2 or 3, preferably 1 or 2

R₄O(R₅O)ₘR₆ Formula 2:
wherein
R₄ is n-propyl or isopropyl, preferably n-propyl
R₅ is isopropyl
R₆ is hydrogen or methyl, preferably hydrogen
m is 1, 2 or 3 preferably 1 or 2

Suitable glycol ether solvents according to Formula 1 include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-butyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula 1 are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

Most preferred glycol ethers according to Formula 1 are propyleneglycol n-butyl ether, dipropyleneglycol n-butyl ether, and mixtures thereof.

Suitable glycol ether solvents according to Formula 2 include propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

Preferred glycol ether solvents according to Formula 2 are propyleneglycol n-propyl ether, dipropyleneglycol n-propyl ether, and mixtures thereof.

Most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, more particularly from the E-series (ethylene glycol based) Glycol Ethers and the P-series (propylene glycol based) Glycol Ethers line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

The glycol ether solvent is typically present at a level of less than 10%, more preferably from 1% to 7% by weight of the composition.

The composition can comprise a further solvent, such as solvents selected from the group consisting of C2-C4 alcohols, C2-C4 polyols, poly alkylene glycol and mixtures thereof.

The Surfactant System

The liquid hard surface treatment composition comprises from 3% to 15% by weight of a surfactant system. Preferably, the hard surface cleaning composition comprises surfactant at a level of from 6% to 12% and more preferably from 7.5% to 12% by weight of the composition.

For improved release of stains, the surfactant system and the glycol ether solvent are in a weight ratio of from 5:1 to 1:1.

Nonionic Surfactant:

The liquid hard surface cleaning composition preferably comprises a nonionic surfactant. The nonionic surfactant can be selected from the group consisting of: alkoxylated nonionic surfactants, alkyl polyglycosides, amine oxides, and mixture thereof. Typically, the liquid hard surface cleaning composition may comprise from 1.0% to 10.0%, preferably from 3.0% to 9.5%, more preferably from 4.0% to 9.0% and most preferably from 5.0% to 8.0% by weight of the total composition of the nonionic surfactant.

The combination of the solvent with nonionic surfactant, especially when the nonionic surfactant comprises amine oxide surfactant, results in improved removal of stains, especially hydrophobic stains.

The hard surface cleaning composition can comprise from 1% to 10%, preferably from 1.5% to 8%, more preferably from 2% to 7% and most preferably from 2% to 6% by weight of the composition of alkoxylated alcohol, preferably ethoxylated alcohol.

Suitable alkoxylated nonionic surfactants include primary C₆-C₁₆ alcohol polyglycol ether i.e. ethoxylated alcohols having 6 to 16 carbon atoms in the alkyl moiety and 4 to 30 ethylene oxide (EO) units. When referred to for example C₉₋₁₄ it is meant average carbons and alternative reference to for example EO8 is meant average ethylene oxide units.

Suitable alkoxylated nonionic surfactants are according to the formula RO-(A)ₙH, wherein: R is a C₆ to C₁₈, preferably a C₈ to C₁₆, more preferably a C₈ to C₁₂ alkyl chain, or a C₆ to C₂₈ alkyl benzene chain; A is an ethoxy or propoxy or butoxy unit, and wherein n is from 1 to 30, preferably from 1 to 15 and, more preferably from 4 to 12 even more preferably from 5 to 10. Preferred R chains for use herein are the C₈ to C₂₂ alkyl chains. Even more preferred R chains for use herein are the C₉ to C₁₂ alkyl chains. R can be linear or branched alkyl chain.

Suitable ethoxylated nonionic surfactants for use herein are Dobanol® 91-2.5 (HLB=8.1; R is a mixture of C₉ and C₁₁ alkyl chains, n is 2.5), Dobanol® 91-10 (HLB=14.2; R is a mixture of C₉ to C₁₁ alkyl chains, n is 10), Dobanol® 91-12 (HLB=14.5; R is a mixture of C₉ to C₁₁ alkyl chains, n is 12), Greenbentine DE80 (HLB=13.8, 98 wt % C10 linear alkyl chain, n is 8), Marlipal 10-8 (HLB=13.8, R is a C10 linear alkyl chain, n is 8), Lialethl® 11-5 (R is a C₁₁ alkyl chain, n is 5), Isalchem® 11-5 (R is a mixture of linear and branched C11 alkyl chain, n is 5), Lialethl® 11-21 (R is a mixture of linear and branched C₁₁ alkyl chain, n is 21), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Dobanol® 91-5, Neodol® 11-5, Lialethl® 11-21 Lialethl® 11-5 Isalchem® 11-5 Isalchem® 11-21 Dobanol® 91-8, or Dobanol® 91-10, or Dobanol® 91-12, or mixtures thereof. These Dobanol®/Neodol® surfactants are commercially available from SHELL. These Lutensol® surfactants are commercially available from BASF and these Tergitol® surfactants are commercially available from Dow Chemicals.

Suitable chemical processes for preparing the alkoxylated nonionic surfactants for use herein include condensation of corresponding alcohols with alkylene oxide, in the desired proportions. Such processes are well known to the person skilled in the art and have been extensively described in the art, including the OXO process and various derivatives thereof. Suitable alkoxylated fatty alcohol nonionic surfactants, produced using the OXO process, have been marketed under the tradename NEODOL® by the Shell Chemical Company. Alternatively, suitable alkoxylated nonionic surfactants can be prepared by other processes such as the Ziegler process, in addition to derivatives of the OXO or Ziegler processes.

Preferably, said alkoxylated nonionic surfactant is a C₉₋₁₁ EO5 alkylethoxylate, C₁₂₋₁₄ EO5 alkylethoxylate, a C₁₁ EO5 alkylethoxylate, C₁₂₋₁₄ EO21 alkylethoxylate, or a C₉₋₁₁ EO8 alkylethoxylate or a mixture thereof. Most preferably, said alkoxylated nonionic surfactant is a C₁₁ EO5 alkylethoxylate or a C₉₋₁₁ EO8 alkylethoxylate or a mixture thereof.

Alkyl polyglycosides are biodegradable nonionic surfactants which are well known in the art, and can also be used in the compositions of the present invention. Suitable alkyl polyglycosides can have the general formula CₙH₂ₙ₊₁O(C₆H₁₀O₅)ₓH wherein n is preferably from 9 to 16, more preferably 11 to 14, and x is preferably from 1 to 2, more preferably 1.3 to 1.6.

Suitable amine oxide surfactants include: R₁R₂R₃NO wherein each of R₁, R₂ and R₃ is independently a saturated or unsaturated, substituted or unsubstituted, linear or branched hydrocarbon chain having from 10 to 30 carbon atoms. Preferred amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain. Preferably, the liquid hard surface cleaning composition comprises from 0.05% to 6%, preferably from 0.1% to 5%, more preferably from 0.1% to 4.5% and most preferably from 0.1% to 4% by weight of the composition of amine oxide surfactant.

A highly preferred amine oxide is C₁₂-C₁₄ dimethyl amine oxide, commercially available from Albright & Wilson, C₁₂-C₁₄ amine oxides commercially available under the trade name Genaminox® LA from Clariant or AROMOX® DMC from AKZO Nobel.

The nonionic surfactant is preferably a low molecular weight nonionic surfactant, having a molecular weight of less than 950 g/mol, more preferably less than 500 g/mol.

Anionic Surfactant:

The liquid hard surface cleaning composition can comprise an anionic surfactant. The anionic surfactant can be selected from the group consisting of: an alkyl sulphate, an alkyl alkoxylated sulphate, a sulphonic acid or sulphonate surfactant, and mixtures thereof. The liquid hard surface cleaning composition can comprise greater than 0.1%, preferably from 0.1% to 5%, preferably from 0.5% to 4%, and most preferably from 1.5% to 3.5% by weight of anionic surfactant.

Suitable anionic surfactants can be selected from the group consisting of: linear alkylbenzene sulphonic acid, alkyl sulphate, alkyl ether sulphate, and salts thereof, preferably linear alkylbenzene sulphonic acid and salts thereof.

Suitable alkyl sulphates for use herein include water-soluble salts or acids of the formula ROSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphates include C₁₂₋₁₄ alkyl sulphate like EMPICOL® 0298/, EMPICOL® 0298/F or EMPICOL® XLB commercially available from Huntsman By “linear alkyl sulphate” it is meant herein a non-substituted alkyl sulphate wherein the linear alkyl chain comprises from 6 to 16 carbon atoms, preferably from 8 to 14 carbon atoms, and more preferably from 10 to 14 carbon atoms, and wherein this alkyl chain is sulphated at one terminus.

Suitable sulphonated anionic surfactants for use herein are all those commonly known by those skilled in the art. Preferably, the sulphonated anionic surfactants for use herein are selected from the group consisting of: alkyl sulphonates; alkyl aryl sulphonates; naphthalene sulphonates; alkyl alkoxylated sulphonates; and C₆-C₁₆ alkyl alkoxylated linear or branched diphenyl oxide disulphonates; and mixtures thereof.

Suitable alkyl sulphonates for use herein include water-soluble salts or acids of the formula RSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₁₈ linear or branched saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₂-C₁₆ paraffin sulphonate like Hostapur® SAS commercially available from Clariant. Particularly preferred alkyl aryl sulphonates are alkyl benzene sulphonates commercially available under trade name Nansa® available from Huntsman.

By “linear alkyl sulphonate” it is meant herein a non-substituted alkyl sulphonate wherein the alkyl chain comprises from 6 to 18 carbon atoms, preferably from 8 to 16 carbon atoms, and more preferably from 10 to 16 carbon atoms, and wherein this alkyl chain is sulphonated at one terminus.

Suitable alkoxylated sulphonate surfactants for use herein are according to the formula R(A)ₘSO₃M, wherein R is an unsubstituted C₆-C₁₈ alkyl, hydroxyalkyl or alkyl aryl group, having a linear or branched C₆-C₁₈ alkyl component, preferably a C₈-C₁₆ alkyl or hydroxyalkyl, more preferably C₁₂-C₁₆ alkyl or hydroxyalkyl, and A is an ethoxy or propoxy or butoxy unit, and m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like.

Exemplary surfactants are C₁₂-C₁₈ alkyl polyethoxylate (1.0) sulphonate (C₁₂-C₁₈E(1.0)SM), C₁₂-C₁₈ alkyl polyethoxylate (2.25) sulphonate (C₁₂-C₁₈E(2.25)SM), C₁₂-C₁₈ alkyl polyethoxylate (3.0) sulphonate (C₁₂-C₁₈E(3.0)SM), and C₁₂-C₁₈ alkyl polyethoxylate (4.0) sulphonate (C₁₂-C₁₈E(4.0)SM), wherein M is conveniently selected from sodium and potassium. Particularly suitable alkoxylated sulphonates include alkyl aryl polyether sulphonates like Triton X-200® commercially available from Dow Chemical.

Preferably said sulphated or sulphonated anionic surfactant for use herein is selected from the group consisting of alkyl sulphates (AS) preferably C₁₂, C₁₃, C₁₄ and C₁₅ AS, sodium linear alkyl sulphonate (NaLAS), sodium paraffin sulphonate NaPC₁₂₋₁₆S, and mixtures thereof. Most preferably sulphated or sulphonated anionic surfactant for use herein is selected from the group consisting of alkyl sulphates (AS) preferably, C₁₂, C₁₃, C₁₄ and C₁₅ AS, sodium linear alkyl sulphonate (NaLAS), sodium paraffin sulphonate NaPC₁₂₋₁₆S and mixtures thereof.

Typically, the liquid composition herein may comprise from 0.5% to 9.5% by weight of the total composition of said sulphated or sulphonated anionic surfactant, preferably from 1.0% to 5.0%, more preferably from 1.5% to 3.5% and most preferably from 2.0% to 3.0%.

If both nonionic and anionic surfactant are present, the weight ratio of anionic surfactant to nonionic surfactant is preferably from 0.01 to 0.50, more preferably from 0.10 to 0.45, more preferably from 0.30 to 0.40.

Additional Surfactant:

The hard surface cleaning composition may comprise up to 15% by weight of an additional surfactant, preferably selected from: an amphoteric, zwitterionic, and mixtures thereof. More preferably, the hard surface cleaning composition can comprise from 0.5% to 5%, or from 0.5% to 3%, or from 0.5% to 2% by weight of the additional surfactant.

Suitable zwitterionic surfactants typically contain both cationic and anionic groups in substantially equivalent proportions so as to be electrically neutral at the pH of use, and are well known in the art. Some common examples of zwitterionic surfactants (such as betaine/sulphobetaine surfactants) are described in U.S. Pat. Nos. 2,082,275, 2,702,279 and 2,255,082.

Amphoteric surfactants can be either cationic or anionic depending upon the pH of the composition. Suitable amphoteric surfactants include dodecylbeta-alanine, N-alkyltaurines such as the one prepared by reacting dodecylamine with sodium isethionate, as taught in U.S. Pat. No. 2,658,072, N-higher alkylaspartic acids such as those taught in U.S. Pat. No. 2,438,091, and the products sold under the trade name “Miranol”, as described in U.S. Pat. No. 2,528,378. Other suitable additional surfactants can be found in McCutcheon's Detergents and Emulsifers, North American Ed. 1980.

Optional Ingredients:

Thickener:

The liquid hard surface cleaning composition can comprise a thickener. An increased viscosity, especially low shear viscosity, provides longer contact time and therefore improved penetration of greasy soil and/or particulated greasy soil to improve cleaning effectiveness, especially when applied neat to the surface to be treated. Moreover, a high low shear viscosity improves the phase stability of the liquid cleaning composition, and especially improves the stability of the copolymer in compositions in the liquid hard surface cleaning composition. Hence, preferably, the liquid hard surface cleaning composition, comprising a thickener, has a viscosity of from 50 Pa·s to 650 Pa·s, more preferably 100 Pa·s to 550 Pa·s, most preferably 150 Pa·s to 450 Pa·s, at 20° C. when measured with a AD1000 Advanced Rheometer from Atlas® shear rate 10 s⁻¹ with a coned spindle of 40 mm with a cone angle 2° and a truncation of ±60 μm.

Suitable thickeners include polyacrylate based polymers, preferably hydrophobically modified polyacrylate polymers; hydroxyl ethyl cellulose, preferably hydrophobically modified hydroxyl ethyl cellulose, xanthan gum, hydrogenated castor oil (HCO) and mixtures thereof.

Preferred thickeners are polyacrylate based polymers, preferably hydrophobically modified polyacrylate polymers. Preferably a water soluble copolymer based on main monomers acrylic acid, acrylic acid esters, vinyl acetate, methacrylic acid, acrylonitrile and mixtures thereof, more preferably copolymer is based on methacrylic acid and acrylic acid esters having appearance of milky, low viscous dispersion. Most preferred hydrologically modified polyacrylate polymer is Rheovis® AT 120, which is commercially available from BASF.

The most preferred thickener used herein is a methacrylic acid/acrylic acid copolymer, such as Rheovis® AT 120, which is commercially available from BASF.

When used, the liquid hard surface cleaning composition comprises from 0.1% to 10.0% by weight of the total composition of said thickener, preferably from 0.2% to 5.0%, more preferably from 0.2% to 2.5% and most preferably from 0.2% to 2.0%.

Chelating Agent:

The liquid hard surface cleaning composition can comprise a chelating agent or crystal growth inhibitor. Suitable chelating agents, in combination with the surfactant system, improve the shine benefit. Chelating agent can be incorporated into the compositions in amounts ranging from 0.05% to 5.0% by weight of the total composition, preferably from 0.1% to 3.0%, more preferably from 0.2% to 2.0% and most preferably from 0.2% to 0.4%.

Suitable phosphonate chelating agents include ethylene diamine tetra methylene phosphonates, and diethylene triamine penta methylene phosphonates (DTPMP), and can be present either in their acid form or as salts.

A preferred biodegradable chelating agent for use herein is ethylene diamine N,N′-disuccinic acid, or alkali metal, or alkaline earth, ammonium or substitutes ammonium salts thereof or mixtures thereof, for instance, as described in U.S. Pat. No. 4,704,233. A more preferred biodegradable chelating agent is L-glutamic acid N,N-diacetic acid (GLDA) commercially available under tradename Dissolvine 47S from Akzo Nobel.

Suitable amino carboxylates include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA), both in their acid form, or in their alkali metal, ammonium, and substituted ammonium salt forms. Particularly suitable amino carboxylate to be used herein is propylene diamine tetracetic acid (PDTA) which is, for instance, commercially available from BASF under the trade name Trilon FS® and methyl glycine di-acetic acid (MGDA). Most preferred aminocarboxylate used herein is diethylene triamine pentaacetate (DTPA) from BASF. Further carboxylate chelating agents for use herein include salicylic acid, aspartic acid, glutamic acid, glycine, malonic acid or mixtures thereof.

Polymers:

The liquid hard surface cleaning composition may comprise a polymer. For instance, a polymer further improving the grease removal performance of the liquid composition due to the specific sudsing/foaming characteristics they provide to the composition. Suitable polymers for use herein are disclosed in co-pending EP patent application EP2272942 (09164872.5) and granted European patent EP2025743 (07113156.9).

The polymer can be selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; and mixtures thereof.

Typically, the liquid hard surface cleaning composition may comprise from 0.005% to 5.0% by weight of the total composition of said polymer, preferably from 0.10% to 4.0%, more preferably from 0.1% to 3.0% and most preferably from 0.20% to 1.0%.

Fatty Acid:

The liquid hard surface cleaning composition may comprise a fatty acid as a highly preferred optional ingredient, particularly as suds suppressors. Fatty acids are desired herein as they reduce the sudsing of the liquid composition when the composition is rinsed off the surface to which it has been applied.

Suitable fatty acids include the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms. Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil. For example coconut fatty acid is commercially available from KLK OLEA under the name PALMERAB1211.

Typically, the liquid hard surface cleaning composition may comprise up to 6.0% by weight of the total composition of said fatty acid, preferably from 0.1% to 3.0%, more preferably from 0.1% to 2.0% and most preferably from 0.15% to 1.5% by weight of the total composition of said fatty acid.

Branched Fatty Alcohol:

The liquid hard surface cleaning composition may comprise a branched fatty alcohol, particularly as suds suppressors. Suitable branched fatty alcohols include the 2-alkyl alkanols having an alkyl chain comprising from 6 to 16, preferably from 7 to 13, more preferably from 8 to 12, most preferably from 8 to 10 carbon atoms and a terminal hydroxy group, said alkyl chain being substituted in the a position (i.e., position number 2) by an alkyl chain comprising from 1 to 10, preferably from 2 to 8 and more preferably 4 to 6 carbon atoms. Such suitable compounds are commercially available, for instance, as the Isofol® series such as Isofol® 12 (2-butyl octanol) or Isofol® 16 (2-hexyl decanol) commercially available from Sasol

Typically, the liquid hard surface cleaning composition may comprise up to 2.0% by weight of the total composition of said branched fatty alcohol, preferably from 0.10% to 1.0%, more preferably from 0.1% to 0.8% and most preferably from 0.1% to 0.5%.

Other Optional Ingredients:

The liquid hard surface cleaning compositions may comprise a variety of other optional ingredients depending on the technical benefit aimed for and the surface treated. Suitable optional ingredients for use herein include perfume, builders, other polymers, buffers, bactericides, hydrotropes, colorants, stabilisers, radical scavengers, abrasives, soil suspenders, brighteners, anti-dusting agents, dispersants, dye transfer inhibitors, pigments, silicones and/or dyes.

Method of Cleaning a Surface:

Liquid hard surface cleaning compositions described herein are suitable for cleaning household surfaces. In particular, such compositions are particularly useful for removing stains, especially hydrophobic stains, and most especially hydrophobic stains selected from the group consisting of: oils, fats, polymerized grease, and mixtures thereof.

Oils are nonpolar substances which are liquid at ambient temperatures (21° C.), and are both hydrophobic (immiscible with water) and lipophilic (miscible with other oils and organic solvents). Oils typically have a high carbon and hydrogen content. Oil includes classes of chemical compounds that may be otherwise unrelated in structure, properties, and uses. Oils may be derived from animal, vegetable, or petrochemicals sources. They are typically used for food, fuel, lubrication, and the manufacture of paints, plastics, and other materials.

Fats are soft greasy solids at ambient temperatures (21° C.), and are also both hydrophobic (immiscible with water) and lipophilic (miscible with other oils and organic solvents). Fats may be animal, vegetable, or petrochemical in origin. They are also typically used for food, fuel, lubrication, and the manufacture of paints, plastics, and other materials.

Polymerised grease are cooked-, baked- or burnt-on oils and fats that have been heated to a temperature, of left sufficiently long, that they polymerise and typically also have an increased viscosity.

Liquid compositions comprising the glycol ether solvents are particularly suitable for treating oils, fats, and polymerized grease which have been derived from animal, or vegetable sources.

For general cleaning, especially of floors, the preferred method of cleaning comprises the steps of: optionally pre-wetting the hard surface, applying the hard surface cleaning composition, and optionally rinsing the hard surface with water.

The hard surface cleaning composition can be applied neat to the surface, or first diluted. When diluted, the liquid hard surface cleaning composition is preferably diluted to a dilution level of from 0.1% to 2% by volume before application. In preferred embodiments, the liquid hard surface cleaning composition may be diluted to a level of from 0.3% to 1.5% by volume. The liquid hard surface cleaning composition may be diluted to a level of from 0.4% to 0.6% by volume, especially where the liquid hard surface cleaning composition has a total surfactant level of greater than or equal to 5% by weight. Where the liquid hard surface cleaning composition has a total surfactant level of less than 5% by weight, the liquid hard surface cleaning composition may be diluted to a level of from 0.7% to 1.4% by volume. In preferred embodiments, the liquid hard surface cleaning composition is diluted with water.

The dilution level is expressed as a percent defined as the fraction of the liquid hard surface cleaning composition, by volume, with respect to the total amount of the diluted composition. For example, a dilution level of 5% by volume is equivalent to 50 ml of the liquid hard surface cleaning composition being diluted to form 1000 ml of diluted composition.

The diluted composition can be applied by any suitable means, including using a mop, sponge, or other suitable implement.

The hard surface may be rinsed, preferably with clean water, in an optional further step.

Alternatively, and especially for particularly dirty or hard to remove hydrophobic stains, the liquid hard surface cleaning composition can be applied neat to the hard surface. It is believed that the combination of solvent, surfactant, and pH results in improved penetration and dispersion of stains, and especially of hydrophobic stains, leading to improved surfactancy action and stain removal.

By “neat”, it is to be understood that the liquid composition is applied directly onto the surface to be treated without undergoing any significant dilution, i.e., the liquid composition herein is applied onto the hard surface as described herein, either directly or via an implement such as a sponge, without first diluting the composition. By significant dilution, what is meant is that the composition is diluted by less than 10%, preferably less than 5%, more preferably less than 3% by volume of the composition. Such dilutions can arise from the use of damp implements to apply the composition to the hard surface, such as sponges which have been “squeezed” dry.

In another preferred embodiment of the present invention said method of cleaning a hard surface includes the steps of applying, preferably spraying, said liquid composition onto said hard surface, leaving said liquid composition to act onto said surface for a period of time to allow said composition to act, with or without applying mechanical action, and optionally removing said liquid composition, preferably removing said liquid composition by rinsing said hard surface with water and/or wiping said hard surface with an appropriate instrument, e.g., a sponge, a paper or cloth towel and the like. Such compositions can be provided in a spray dispenser.

Methods:

A) pH Measurement:

The pH is measured on the neat composition, at 25° C., using a Sartarius PT-10P pH meter with gel-filled probe (such as the Toledo probe, part number 52 000 100), calibrated according to the instructions manual.

B) Reserve Alkalinity:

The reserve alkalinity is measured to pH 7.0 via titration of a 1% solution of the composition using g sodium hydroxide solution, with 100 grams of product at 20° C.

### EXAMPLES

The following liquid hard surface cleaning compositions were prepared by simple mixing:

| | A | B | C | D | E* |
|---|---|---|---|---|---|
| | wt % | wt % | wt % | wt % | wt % |
| HLAS¹ | 1.80 | 1.80 | 1.80 | 1.80 | 1.80 |
| Neodol C9/11 EO8² | 6.20 | 6.20 | 6.20 | 6.20 | 6.20 |
| C12-14 dimethyl amine | 1.50 | 1.50 | 1.50 | 1.50 | 1.50 |
| oxide³ | | | | | |
| 2-butyl octanol⁴ | 0.10 | 0.10 | 0.10 | 0.10 | 0.10 |
| TPK fatty acid | 1.00 | 1.00 | 1.00 | 1.00 | 1.00 |
| Sodium carbonate | 0.55 | 0.55 | 0.55 | 0.55 | 0.55 |
| Citric acid | 0.30 | 0.30 | 0.30 | 0.30 | 0.30 |
| Sodium hydroxide | 0.73 | 0.73 | 0.73 | 0.73 | 0.73 |
| DTPMP⁵ | 0.30 | 0.30 | 0.30 | 0.30 | 0.30 |
| Propylene glycol | 2.00 | — | — | — | — |
| n-propyl ether⁶ | | | | | |
| Dipropylene glycol | — | 2.00 | — | — | — |
| n-propyl ether⁷ | | | | | |
| Propylene glycol | — | — | 2.00 | — | — |
| n-butyl ether⁸ | | | | | |
| Dipropylene glycol | — | — | — | 2.00 | — |
| n-butyl ether⁹ | | | | | |
| Hydrophobically | 0.82 | 0.82 | 0.82 | 0.82 | 0.82 |
| modified-polyacrylate¹⁰ | | | | | |
| Minors (including | up to | up to | up to | up to | up to |
| perfume, dyes, | 100% | 100% | 100% | 100% | 100% |
| and preservative) | | | | | |
| and Water | | | | | |
| pH | 10 | 10 | 10 | 10 | 10 |

*Comparative
¹linear alkylbenzene sulphonic acid, commercially available from Huntsman
²nonionic surfactant commercially available from Shell.
³amine oxide nonionic surfactant commercially available from Huntsman
⁴commercially available from Sasol as Isofol 12 ® .
⁵diethylene triamine penta methylene phosphonate, available from Monsanto
⁶Dowanol PnP, from The Dow Chemical Company
⁷Dowanol DPnP, from The Dow Chemical Company
⁸Dowanol PnB, from The Dow Chemical Company
⁹Dowanol DPnB, from The Dow Chemical Company
¹⁰Sokalan ® AT 120, which is commercially available from BASF

The ability of the compositions to penetrate oil was assessed by measuring the breakthrough time, using the following methodology:

35 gram of water solution containing 0.15% by weight of xanthan gum (supplied by Keltrol™ RD from CP-kelco) was poured into a glossy white ceramic dish plate (Supplied by Ikea—Item: S.Pryle #13781 diameter 26.5 cm).

Olive oil (Sold by Unilever under the Bertoli brand, item number L5313R HO756 MI0002) was dyed red through the addition of 0.05% by weight of red dye (Waxoline Red, red dye pigment supplied by Avecia), stirring for 1 hour in order to provide a homogeneous dye distribution. Then 2.5 grams of the dyed olive oil was delicately deposited onto the water surface thus forming a thin disk of oil layer. The oil disk diameter was measured to ensure that the diameter did not exceed a variation amongst the replicates of more than 20% from the average value.

1 drop of the hard surface cleaning composition was delicately deposited on to the oil layer, in the middle of the oil disk from a 5 ml Pasteur pipette (Supplied by VWR—Item: 5 ml #612-1684), from a height of less than 5 mm.

The breakthrough time was measured as the time recorded from the deposition of the solution drop to the opening of the oil disk identified by the appearance of the water layer in the middle of the oil disk. 8 replicates were required per sample to calculate the average breakthrough time.

The average breakthrough time is shown in the table below:

| | A | B | C | D | E* |
|---|---|---|---|---|---|
| Average breakthrough time (s) | 28.0 | 26.6 | 29.8 | 27.1 | 33.8 |

*Comparative

As can be seen from the table above, compositions of the present invention, comprising the glycol ether solvent according to formula I (Dowanol PnB, Dowanol DPnB) or formula II (Dowanol PnP, Dowanol DPnP), improve the penetration of the composition through hydrophobic material, such as oil. Since the solvent improves penetration of the liquid composition into the stain, the improved surfactancy in combination with the alkaline pH improves the dispersion of such hydrophobic stains.

The compositions below are non-limiting embodiments of the present invention:

| | E | F | G | H | I | J | K | L | M |
|---|---|---|---|---|---|---|---|---|---|
| | wt % | wt % | wt % | wt % | wt % | wt % | wt % | wt % | wt % |
| C9/11 EO8² | 3 | — | 7.0 | — | — | — | 6.0 | 6.0 | 6.2 |
| C9/11EO5¹⁰ | — | 5 | — | 3.5 | — | — | — | — | — |
| C13/15 EO30¹¹ | — | — | — | 3.5 | — | — | — | — | — |
| C8/10 EO8¹² | 2 | | — | — | 7.0 | 6.0 | — | — | — |
| NaLAS¹³ | 5 | | 1.8 | — | — | 2.60 | — | 2.25 | 1.80 |
| NAPS¹⁴ | — | — | — | 3.1 | 3.0 | — | 2.60 | — | — |
| C12-14 dimethyl | 2 | 5 | 1.50 | 3.9 | 2.0 | 3 | 2 | 1.25 | 1.50 |
| amine oxide³ | | | | | | | | | |
| C12-14 betaine¹⁵ | — | — | — | — | 1.0 | — | 2 | — | — |
| Hydrophobically | — | — | 0.75 | — | — | — | 0.70 | 0.65 | 0.65 |
| modified- | | | | | | | | | |
| polyacrylate⁹ | | | | | | | | | |
| HM-HEC¹⁶ | — | — | — | 0.6 | 0.8 | — | — | — | — |
| Xanthan gum¹⁷ | — | — | — | — | — | 0.42 | — | — | — |
| Na₂CO₃ | 0.40 | 0.4 | 0.75 | 0.1 | 0.3 | 0.50 | 0.55 | 0.4 | 0.55 |
| Citric acid | 0.30 | 0.3 | 0.3 | 0.75 | 0.75 | 0.30 | 0.3 | 0.3 | 0.30 |
| Caustic | 0.25 | 0. 25 | 0.72 | 0.5 | 0.5 | 0.3 | 0.65 | 0.65 | 0.66 |
| Fatty acid | 0.15 | — | 1.0 | 0.20 | 0.50 | 0.50 | 0.40 | 0.40 | 1.0 |
| Propylene glycol | 5 | — | — | — | 3 | — | 4 | — | 2 |
| n-propyl ether⁶ | | | | | | | | | |
| Dipropylene | — | 4 | — | — | 3 | — | — | 3 | — |
| glycol n-propyl | | | | | | | | | |
| ether⁷ | | | | | | | | | |
| Propyleneglycol | — | — | 6 | — | — | 4 | 3 | — | — |
| ether n-butyl | | | | | | | | | |
| ether⁸ | | | | | | | | | |
| Dipropylene | — | — | — | 4 | — | 2 | — | 3 | 4 |
| glycol n-butyl | | | | | | | | | |
| ether⁹ | | | | | | | | | |
| DTPA¹⁸ | — | — | — | — | — | — | 0.25 | 0.25 | — |
| GLDA¹⁹ | — | — | — | 0.3 | 0.3 | — | — | — | — |
| IPA²⁰ | — | — | — | — | — | 2.0 | — | — | — |
| Minors and Water | up to | up to | up to | up to | up to | up to | up to | up to | up to |
| | 100% | 100% | 100% | 100% | 100% | 100% | 100% | 100% | 100% |
| pH | 10.5 | 10.3 | 10.3 | 9.5 | 9.0 | 10.5 | 10.3 | 10.5 | 10.3 |

¹⁰nonionic surfactant commercially available from ICI or Shell.
¹¹nonionic surfactant commercially available from BASF
¹²nonionic surfactant commercially available from Sasol
¹³sodium linear alkylbenzene sulphonate commercially available from Huntsman
¹⁴sodium paraffin sulphonate commercially available from ICS
¹⁵amphoteric surfactant commercially available from MC Intyre group
¹⁶Hydrophobically modified hydroxyethylcellulose (cetylhydroxethylcellulose)
¹⁷commercially available from CP Kelco
¹⁸diethylene triamine pentaacetate, available from BASF
¹⁹Tetrasodium Glutamate Diacetate, commercially available from Akzo Nobel
²⁰isopropanol, commercially available from J T Baker

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hard surface cleaning composition comprising:
a) from about 3% to about 15% by weight of the composition of a surfactant system; and
b) a glycol ether solvent selected from the group consisting of glycol ethers of:
i. Formula I: R₁O(R₂O)ₙR₃;
ii. Formula II: R₄O(R₅O)ₘR₆; and
iii. mixtures thereof;
wherein:
R₁ is a linear or branched C₄, C₅ or C₆ alkyl or a substituted or unsubstituted phenyl, R₂ is ethyl or isopropyl, R₃ is hydrogen or methyl, and n is 1, 2 or 3;
R₄ is n-propyl or isopropyl, R₅ is isopropyl, R₆ is hydrogen or methyl and m is 1, 2 or 3;
wherein the surfactant system and the glycol ether solvent are in a weight ratio of from 5:1 to 1:1, and the composition has a pH of greater than about 7.

2. The hard surface cleaning composition according to claim 1, wherein the total surfactant level is from about 6% to about 12% by weight of the composition.

3. The hard surface cleaning composition according to claim 1, wherein the composition comprises from about 1.0 wt % to about 10.0 wt % by weight of the total composition of a nonionic surfactant.

4. The hard surface cleaning composition according to claim 1, wherein the composition comprises from about 1.0 wt % to about 10 wt % of alkoxylated alcohol, preferably ethoxylated alcohol.

5. The hard surface cleaning composition according to claim 1, wherein the composition comprises from about 0.05% to about 6% by weight of amine oxide surfactant.

6. The hard surface cleaning composition according to claim 1, wherein the surfactant system comprises anionic surfactant, present at a level of greater than about 0.1% of the composition.

7. The hard surface cleaning composition according to claim 1, wherein the anionic surfactant is selected from the group consisting of: linear alkylbenzene sulphonic acid, alkyl sulphate, alkyl ether sulphate, and salts thereof.

8. The hard surface cleaning composition according to claim 1, wherein the composition has a pH of from about 7.0 to about 12.

9. The hard surface cleaning composition according to claim 1, wherein the composition has a reserve alkalinity of from about 0.1 to about 1 expressed as g NAOH/100 ml of composition at a pH of about 7.

10. The hard surface cleaning composition according to claim 1, wherein the glycol ether solvent is present at a level of less than about 10% by weight of the composition.

11. The hard surface cleaning composition according to claim 1, wherein the composition comprises an alkanolamine.

12. The hard surface cleaning composition according to claim 1, wherein the composition further comprises a further solvent selected from the group consisting of C2-C4 alcohols, C2-C4 polyols, poly alkylene glycol and mixtures thereof.

13. The hard surface cleaning composition according to claim 1, wherein the composition has a viscosity of from about 1 cps to about 650 cps, when measured at about 20° C. with a AD1000 Advanced Rheometer from Atlas® shear rate 10 s⁻¹ with a coned spindle of 40 mm with a cone angle of about 2° and a truncation of about 60 μm.

14. A method of treating a hard surface, especially removing stains from a hard surface, comprising the steps of:
a) optionally pre-wetting the hard surface;
b) applying the hard surface cleaning composition according to any preceding claims;
c) optionally rinsing the hard surface with water.

15. The method of use of a hard surface treatment composition comprising a glycol ether solvent and greater than about 3% by weight of surfactant, and having a pH of greater than about 7, for removing stains, especially hydrophobic stains.
